(19) United States
(12) Patent Application Publication
(10) Pub. No.: US 2010/0168069 A1
(43) Pub. Date: Jul. 1, 2010

(54) INSECT REPELLENT

(76) Inventor: Armand Zurhaar, Western Australia (AU)

Correspondence Address: NIXON & VANDERHYE, PC, 901 NORTH GLEBE ROAD, 11TH FLOOR, ARLINGTON, VA, 22203, US

(21) Appl. No.: 12/377,943

(22) PCT Filed: Aug. 17, 2007
(86) PCT No.: PCT/AU07/01184

§ 371 Date: Feb. 18, 2009

(30) Foreign Application Priority Data
Aug. 18, 2006 (AU) 2006904486

(51) Int. Cl. A01N 57/14; A01P 7/04

(52) U.S. Cl. 514/145

(57) ABSTRACT

The invention provides an insect repellent composition that repels flies, gnats, mosquitoes, lice, ticks, and fleas. The insect repellent composition includes an effective amount of a phosphorous containing compound having the formula (RO)₃P=Oₓ or (RO)₂P=Oₓ(OH) alone or in synergistic combination with any one or more compounds selected from a group comprising C₁₀-C₂₀ mono-unsaturated hydrocarbons, optionally substituted C₁-C₁₀ alkyl esters, and dicarboxylic acids; wherein R is an optionally substituted C₁-C₁₀ alkyl group or aryl or aryl substituted with C₁-C₁₀ alkyl or alkoxy; and x is 0 or 1, and a carrier vehicle.

### FIELD OF THE INVENTION

The present invention relates to an insect repellent, in particular to an insect repellent for use with livestock, such as sheep and cattle. Additionally, the invention relates to an insect repellent composition and a method of repelling an insect from an area.

### BACKGROUND OF THE INVENTION

There are three main species of blowfly which initiate strikes on sheep. The Australian sheep blowfly (Lucilia cuprina) accounts for up to 90 percent of single species strikes across Australia, while the Western Australian brown blowfly (Calliphora albifrontalis) is responsible for initiating up to 15 percent of single species strikes. The lesser brown blowfly (Calliphora dubia) is typically involved in combined strikes. Blowfly maggots developing on sheep can cause a reduced wool clip and a general loss of condition, sometimes resulting in the death of the sheep.

Sheep graziers typically adopt a range of control management activities as part of their blowfly control strategy. Such activities include, but are not limited to, adopting the radical Mules operation with optimum tail length, crutching and drenching at strategic times with insecticides, and suitable grazing management.

Organophosphate insecticides have been widely used since the 1950's for the control of sheep strike, in particular diazinon, fenthion ethyl, chlorfenvinphos, dichlofenthion, coumaphos, and more recently propetamphos. These insecticides are commonly referred to as anticholinesterase compounds as they act be blocking the activity of the enzyme cholinesterase, which is required for removing the neurotransmitter acetylcholine from the post-synaptic membrane after the passage of a nerve impulse.

Organophosphate insecticides can be applied to sheep by either dipping or jetting, although some formulations can be applied as a long wool backline treatment.

Protection against blowfly strike is also provided by the use of synthetic pyrethroids. There are currently two synthetic pyrethroid plus diazinon formulations registered for blowfly and lice control. One of these is applied through a manual applicator and the other using an automatic race.

There is growing resistance to organophosphates and synthetic pyrethroids. The present invention seeks to overcome at least some of the above mentioned disadvantages.

### SUMMARY OF THE INVENTION

The inventors have discovered that it is possible to repel insects from an area by applying to the area one or more chemical repellents contained in a naturally-occurring oil extracted from the tail feathers of birds. Further, the inventors have identified said chemical repellents.

Accordingly, in a first aspect of the invention there is provided an insect repellent comprising an effective amount of a phosphorous containing compound having the formula (RO)₃P=Oₓ or (RO)₂P=Oₓ(OH), alone or in synergistic combination with any one or more compounds selected from a group comprising C₁₀-C₂₀ mono-unsaturated hydrocarbons, optionally substituted C₁-C₁₀ alkyl esters, and dicarboxylic acids; wherein R is an optionally substituted C₁-C₁₀ alkyl group, aryl or aryl substituted with C₁-C₁₀ alkyl or alkoxy, and x is 0 or 1.

In some embodiments R is methyl, ethyl, isopropyl, butyl, phenyl or tolyl. In another embodiment x is 1.

In other embodiments of the invention the insect repellent comprises triphenyl phosphate alone or in synergistic combination with any one or more of the group consisting of nonadecene, heptadecene, 1,2 benzedicarboxylic acid, bis (2-methylpropyl) ester.

In accordance with a second aspect of the invention, there is provided an insect repellent composition comprising an effective amount of a phosphorous containing compound having the formula (RO)₃P=Oₓ or (RO)₂P=Oₓ(OH) alone or in synergistic combination with any one or more compounds selected from a group comprising C₁₀-C₂₀ mono-unsaturated hydrocarbons, optionally substituted C₁-C₁₀ alkyl esters, and dicarboxylic acids; wherein R is an optionally substituted C₁-C₁₀ alkyl group or aryl or aryl substituted with C₁-C₁₀ alkyl or alkoxy; and x is 0 or 1, and a carrier vehicle.

In some embodiments of the invention, the carrier vehicle comprises a liquid, in particular a liquid in which the insect repellent as defined above is miscible or dispersible.

Suitable liquids comprise organic solvents selected from a group consisting of liquid saturated hydrocarbons, polar organic solvents, halogenated hydrocarbons, and oils.

In alternative embodiments of the invention, the carrier vehicle comprises gels, dips, pastes, sprays, aerosols, and other solid formulations such as, for example, a wax-based solid.

In some embodiments, the composition further comprises one or more additives provided that the one or more additives do not detrimentally affect the efficacy of the composition. In some embodiments, the additive is a preservative, a colourant, a stabilizer, a fragrance, or a combination thereof.

In one embodiment, the insect repellent composition comprises up to 20% w/w of the phosphorous containing compound as described above.

In another embodiment of the invention, the insect repellent composition comprises triphenyl phosphate (1-6% w/w), nonadecene (0-1% w/w), heptadecene (0-1% w/w), 1,2-benenedicarboxylic acid (0-1% w/w), bis(2-methylpropyl)ester (0-1% w/w) and a carrier vehicle.

In one preferred embodiment, the insect repellent composition comprises about 1.5-6% w/w triphenylphosphate, 5% w/w eucalyptus oil, 5-10% w/w acetone, 40% w/w linseed oil, 40% w/w liquid hydrocarbon.

In accordance with another aspect of the invention, there is provided a use of an effective amount of a phosphorous containing compound having the formula (RO)₃P=Oₓ or (RO)₂P=Oₓ(OH), alone or in synergistic combination with any one or more compounds selected from a group comprising C₁₀-C₂₀ mono-unsaturated hydrocarbons, optionally substituted C₁-C₁₀ alkyl esters, and dicarboxylic acids; wherein R is an optionally substituted C₁-C₁₀ alkyl group or aryl or aryl substituted with C₁-C₁₀ alkyl or alkoxy; and x is 0 or 1, as an insect repellant.

In accordance with a further aspect of the invention there is provided a method of repelling an insect from an area comprising applying an effective amount of the compounds defined above or an insect repellent composition as defined above to the area.

In one embodiment, the compounds or the composition is topically applied to at least a portion of the area, or at interspersed locations within or on the periphery of the area.

### DETAILED DESCRIPTION OF THE PREFERRED EMBODIMENTS OF THE INVENTION

In one aspect of the invention, an insect repellent is provided. The insect repellent is useful in repelling insects from areas including, but not limited to, animals, particularly large-bodied mammals, plants, particularly food crops, interior areas of building structures, particularly domestic and animal husbandry shelters, and exterior areas adjacent thereto, as well as personal items such as clothing, bedding.

The insect repellent of the present invention particularly repels insects which disturb mammals, particularly livestock such as sheep and cattle, through biting, sucking, or chewing. Suitable examples of such insects include, but are not limited to, flies, gnats, mosquitoes, lice, ticks, and fleas.

In the preferred embodiment of the invention, the insect repellent repels flies and blowflies, in particular the Australian sheep blowfly (Lucilia cuprina), the Western Australian brown blowfly, (Calliphora albifrontalis), the lesser brown blowfly (Calliphora dubia), the Eastern Golden Haired blowfly (Calliphora stygia), the hairy maggot blowfly (Chrysomya rufifacies), steelblue blowfly (Chrysomya saffranea), the housefly (Musca domestica), and the bushfly (Musca vetutissima).

The term “repel” as used herein refers to deterring the insect from remaining on or in close proximity to the area. The term “repel” also encompasses killing the insect, or alternatively, modifying the behaviour and/or responsiveness of the insect so that the presence of the insect on or in close proximity to the area as an irritant thereto is reduced relative to before use of the insect repellent of the present invention in or on the area. The insect repellents of the present invention also function as ectoparasiticides.

In one embodiment of the invention the insect repellent of the present invention comprises an effective amount of a phosphorous containing compound having the formula (RO)₃P=Oₓ or (RO)₂P=Oₓ(OH) alone or in synergistic combination with any one or more compounds selected from a group comprising C₁₀-C₂₀ mono-unsaturated hydrocarbons, optionally substituted C₁-C₁₀ alkyl esters, and dicarboxylic acids; wherein R is an optionally substituted C₁-C₁₀ alkyl group or aryl or aryl substituted with C₁-C₁₀ alkyl or alkoxy; and x is 0 or 1.

Suitable examples of phosphorous containing compounds include, but are not limited to, trimethyl phosphate, triethyl phosphate, tri-isopropyl phosphate, tributyl phosphate, triphenyl phosphate, and tri-p-tolyl phosphate.

Illustrative examples of C₁₀-C₂₀ mono-unsaturated hydrocarbons include, but are not limited to, pentadecene, heptadecene, octadecene, and nonadecene.

Illustrative examples of optionally substituted C₁-C₁₀ alkyl esters include, but are not limited to, bis (2-methylpropyl) ester, methyl acetate, ethyl propanate.

Illustrative examples of dicarboxylic acids include, but are not limited to, 1,2-benzenedicarboxylic acid.

In the preferred embodiment of the invention the insect repellent comprises triphenyl phosphate alone or in synergistic combination with any one or more of compounds in the group consisting of nonadecene, heptadecene, 1,2 benzedicarboxylic acid, bis (2-methylpropyl) ester. Preferably, the insect repellent comprises triphenyl phosphate (1-5% w/w), nonadecene (0-1% w/w), heptadecene (0-1% w/w), 1,2-benenedicarboxylic acid (0-1% w/w), bis(2-methylpropyl)ester (0-1% w/w).

Widespread use of the neat concentrates of the compounds as defined above is likely to be expensive. Additionally, application of the small volumes of neat concentrates may be difficult to deliver or apply to the area without “overdosing” unnecessarily.

Accordingly, there is provided an insect repellent composition comprising an effective amount of a phosphorous containing compound having the formula (RO)₃P=Oₓ or (RO)₂P=Oₓ(OH) alone or in synergistic combination with any one or more compounds selected from a group comprising C₁₀-C₂₀ mono-unsaturated hydrocarbons, optionally substituted C₁-C₁₀ alkyl esters, and dicarboxylic acids; wherein R is an optionally substituted C₁-C₁₀ alkyl group or aryl or aryl substituted with C₁-C₁₀ alkyl or alkoxy; and x is 0 or 1, and a carrier vehicle.

The term “effective amount” as used herein refers to an amount of the one or more compounds defined above or composition sufficient to repel an insect from an area to which the insect repellent of the present invention or composition has been applied. The effective amount of the insect repellent of the present invention or composition will vary with the species of the insect, the nature of the area, the extent of an area from which the insect is to be repelled, and like factors.

The carrier vehicle is selected to enable ready location and retention of the active ingredients of the insect repellent in an area from which it is desirable to repel insects, while at the same time not significantly interfering with its efficacy. It will be understood, therefore, that the insect repellent composition may be formulated differently based on the area and how the composition is to be applied. Furthermore, the carrier vehicle can also serve as a diluent and therefore reduce the associated costs of producing and using the insect repellent of the present invention.

In one embodiment the carrier vehicle is pharmaceutically, physiologically, or veterinarily acceptable for topical application to the area.

The term “pharmaceutically, physiologically, or veterinarily acceptable” as used herein refers to pharmaceutically active agents, physiologically active agents, veterinarily active agents, or inert ingredients which are suitable for use in contact with the skin of animals, including humans, without undue toxicity, incompatibility, instability, irritation, allergic response, and the like, commensurate with a reasonable benefit/risk ratio. It will be understood that the term also refers to pharmaceutically active agents, physiologically active agents, veterinarily active agents, or inert ingredients which are suitable for use in contact with plants without undue toxicity, incompatibility, instability, and the like, commensurate with a reasonable benefit/risk ratio.

The terms “topically applied”, “topically applying”, “or topical application” as used herein refer to directly laying on or spreading on the area using an applicator, such as a brush or a sponge, or by spraying directly onto the area.

Typically, the carrier vehicle comprises upwards from 80% volume of the insect repellent composition of the present invention.

In one embodiment of the invention the carrier vehicle comprises a liquid, in particular a liquid in which the one or more chemical repellents is miscible or dispersible. Suitable liquids comprise organic solvents selected from a group comprising liquid saturated hydrocarbons, polar organic solvents, halogenated hydrocarbons, and oils.

Illustrative examples of suitable liquid saturated hydrocarbons include, but are not limited, to kerosene, white spirits, paraffins or other aliphatic hydrocarbon fractions.

Illustrative examples of suitable polar organic solvents include, but are not limited to, methanol, ethanol, methylated spirits, acetone, benzaldehyde, acetophenone.

Illustrative examples of suitable halogenated hydrocarbons include, but are not limited to, methylene chloride, chloroform, trichloroethylene, carbon tetrachloride, trichlorethane, or trifluoromethane.

Illustrative examples of suitable oils include, but are not limited to, mineral oil, eucalyptus oil, tea tree oil, plant-derived essential oils, linseed oil, flaxseed oil, castor oil, safflower oil, sunflower oil, canola oil, soybean oil, and peanut oil, and combinations thereof.

In the preferred embodiment of the invention, the preferred carrier vehicle is acetone, linseed oil, liquid hydrocarbon or a combination thereof.

Typically, the insect repellent composition comprises up to 20% of the phosphorous containing compound as described above.

In one preferred embodiment, the insect repellent composition comprises about 1-6% w/w triphenylphosphate, 0-5% w/w eucalyptus oil, 5-10% w/w acetone, 40% w/w linseed oil, 40% w/w liquid hydrocarbon.

Alternative carrier vehicles comprise gels, oils, liquid solvents, dips, pastes, sprays, aerosols, and other solid formulations such as, for example, a wax-based solid. Other carrier vehicles can be formulated by those of ordinary skill in the art.

Further, the insect repellent composition of the present invention can contain one or more additives provided that they do not detrimentally affect the repellent effect afforded by the one or more chemical repellents. In one embodiment, the additive is a colourant. In alternative embodiments, the additive is a preservative such as a mould inhibitor or an anti-oxidant, a fragrance, or a stabiliser. A person skilled in the art will readily identify suitable additives which can be combined with the insect repellent composition of the present invention.

In a further alternative embodiment of the invention, the insect repellent composition consists essentially of triphenyl phosphate, nonadecene, heptadecene, 1,2-benenedicarboxylic acid, bis(2-methylpropyl)ester, and a carrier vehicle.

In another alternative embodiment, the insect repellent composition consists essentially of triphenyl phosphate, eucalyptus oil, acetone, linseed oil and liquid hydrocarbon.

The method for the preparation of the insect repellent composition of the present invention comprises mixing the compounds as defined above with a carrier vehicle. The carrier vehicle acts as a diluent or carrier for other materials present in the composition, so as to facilitate their distribution and delivery to the desired location in the area.

The method for repelling insects from an area comprises topically applying to the area an effective amount of the compounds of the present invention or an effective amount of the insect repellent composition.

Alternatively, an effective amount of the compounds or composition of the present invention may be applied to at least a portion of the area, or at interspersed locations within the area or on the periphery of the area to repel insects.

The present invention is useful in animal husbandry, particularly in dissuading insects from disturbing livestock. Additionally, the method can be readily applied to pets and captive animals, and humans including personal items used by or in the vicinity of humans. In particular, the insect repellent or composition of the present invention can be applied to building interiors to deter insects therefrom. The present invention is also suitable for protection of crops, broad acre or horticultural crops, orchards, and vineyards from insects.

The following examples are provided to further illustrate several embodiments of the invention.

### EXAMPLE 1

An avian-based extract was isolated by heating a mixture of tail features (300 g) from sulphur-crested cockatoos in dichloromethane (500 ml) at 60° C. for one hour with stirring. The solvent was removed by rotary evaporation to provide 3 to 5 ml of the avian-based extract.

The oil was analysed by GCMS, which revealed that it comprised in excess of 100 components, including triphenyl phosphate (1.5-2%), nonadecene (0.5-1%), heptadecene (0.5-1%), 1,2-benenedicarboxylic acid (0.5-1%), bis(2-methylpropyl)ester (0.5-1%).

An insect repellent composition was formulated by mixing triphenyl phosphate (5% w/w), eucalyptus oil (5% w/w), acetone (5% w/w), linseed oil (40% w/w) and liquid hydrocarbon (40% w/w).

In the description of the invention, except where the context requires otherwise due to express language or necessary implication, the words “comprise” or variations such as “comprises” or “comprising” are used in an inclusive sense, i.e. to specify the presence of the stated features, but not to preclude the presence or addition of further features in various embodiments of the invention.

It is to be understood that, although prior art use and publications may be referred to herein, such reference does not constitute an admission that any of these form a part of the common general knowledge in the art, in Australia or any other country.

Numerous variations and modifications will suggest themselves to persons skilled in the relevant art, in addition to those already described, without departing from the basic inventive concepts. All such variations and modifications are to be considered within the scope of the present invention, the nature of which is to be determined from the foregoing description.

1. An insect repellent comprising an effective amount of a phosphorous containing compound having the formula (RO)₃P=Oₓ or (RO)₂P=Oₓ(OH) alone or in synergistic combination with at least one a group consisting of: C10-C20 mono-unsaturated hydrocarbons, optionally substituted C₁-C₁₀ alkyl esters, and dicarboxylic acids; wherein R is at least one of an optionally substituted C₁-C₁₀ alkyl group or aryl or aryl substituted with C₁-C₁₀ alkyl and alkoxy; and x is 0 or 1.

2. The insect repellent according to claim 1, wherein R is selected from a group consisting of: methyl, ethyl, isopropyl, butyl, phenyl and tolyl.

3. The insect repellent according to claim 1, wherein x is 1.

4. The insect repellent according to claim 1, comprising triphenyl phosphate alone or in synergistic combination with at least one of a group consisting of: nonadecene, heptadecene, 1,2 benzedicarboxylic acid, and bis (2-methylpropyl) ester.

5. An insect repellent composition comprising an effective amount of an insect repellent as defined in claim 1 and a carrier vehicle.

6. The insect repellent composition according to claim 5, wherein the carrier vehicle comprises a liquid.

7. The insect repellent composition according to claim 6, wherein the insect repellent is miscible or dispersible in a liquid.

8. The insect repellent composition according to claim 6, wherein the liquid comprises organic solvents selected from a group consisting of liquid saturated hydrocarbons, polar organic solvents, halogenated hydrocarbons, and oils.

9. The insect repellent composition according to claim 5, wherein the carrier vehicle is selected from a group consisting of gels, oils, dips, pastes, sprays, aerosols, and solid formulations.

10. The insect repellent composition according to claim 5, further comprising at least one additive.

11. The insect repellent composition according to claim 10, wherein the at least one additive is selected from a group consisting of a preservative, a colorant, a stabilizer, and a fragrance.

12. The insect repellent composition according to claim 5, wherein the composition comprises up to 20% of the phosphorous containing compound.

13. The insect repellent composition according to claim 12, wherein the insect repellent composition comprises triphenyl phosphate (1-6%), nonadecene (0-1%), heptadecene (0-1%), 1,2-benenedicarboxylic acid (0-1%), bis (2-methylpropyl) ester (0-1%) and a carrier vehicle.

14. The insect repellent composition according to claim 12, wherein the composition comprises about 3-6% w/w triphenylphosphate, 5% w/w eucalyptus oil, 5-10% w/w acetone, 40% w/w linseed oil, 40% w/w liquid hydrocarbon.

15. A method comprising:
repelling insects by application of an effective amount of a phosphorous containing compound having the formula (RO)₃P=Oₓ or (RO)₂P=Oₓ(OH) alone or in synergistic combination with at least one compound selected from a group consisting of: C₁₀-C₂₀ mono-unsaturated hydrocarbons, optionally substituted C₁-C₁₀ alkyl esters, and dicarboxylic acids; wherein R is selected from a group consisting of an optionally substituted C₁-C₁₀ an alkyl group, aryl, an aryl substituted with C₁-C₁₀ alkyl and alkoxy; and x is 0 or 1.

16. (canceled)

17. The method according to claim 15 wherein the phosphorous containing compound is topically applied to at least a portion of the area, or at interspersed locations within or on the periphery of the area.

18. (canceled)

19. An insect repellent comprising an effective amount of a phosphorous containing compound having the formula (RO)₃P=Oₓ or (RO)₂P=Oₓ(OH) wherein R is selected from a group consisting of a C₁-C₁₀ alkyl group, an aryl and an aryl substituted with C₁-C₁₀ alkyl or alkoxy; and x is 0 or 1.

20. The insect repellent of claim 19 wherein the phosphorous containing compound is in synergistic combination with at least one a group consisting of: C10-C20 mono-unsaturated hydrocarbons, optionally substituted C₁-C₁₀ alkyl esters, and dicarboxylic acids.
